(19) United States
(12) Patent Application Publication
(10) Pub. No.: US 2020/0118410 A1
(43) Pub. Date: Apr. 16, 2020

(54) METHOD AND SYSTEM FOR MONITORING

(71) Applicant: MARICARE OY, VANTAA (FI)

(72) Inventors: Juha LINDSTRÖM, Espoo (FI); Göran SUNDHOLM, TUUSULA (FI)

(73) Assignee: MARICARE OY, VANTAA (FI)

(21) Appl. No.: 16/088,219

(22) PCT Filed: Mar. 20, 2017
(86) PCT No.: PCT/FI2017/050186

§ 371 Date: Sep. 25, 2018

(30) Foreign Application Priority Data
Mar. 29, 2016 (FI) 20165260

(51) Int. Cl. G08B 21/04; G08B 29/18; G08B 7/06

(52) U.S. Cl. CPC G08B 21/043; G08B 7/06; G08B 29/185

(57) ABSTRACT

A Method and system for observing the presence, location, movement and/or attitude of one or more objects to be monitored in an area to be monitored includes at least one sensor. The sensor or sensors are fitted into some part, such as e.g. on a floor, wall and/or ceiling, of the area to be monitored. The sensor is a sensor detecting movement and/or presence, which sensor is adapted to measure in two measuring ranges that are at a different height, of which the first measuring range is an upper measuring range and the second measuring range is a lower measuring range. The system is adapted to interpret a person as having fallen if an object is not detected in the upper measuring range and an object is detected in the lower measuring range. The system is adapted to send a notification of a fall if a person is interpreted as having fallen and the predetermined criteria attached to sending a notification of a fall are met.

### FIELD OF THE INVENTION

The invention relates to a method and to a system, by means of which persons in an area to be monitored can be observed and monitored.

### BACKGROUND OF THE INVENTION

The monitoring of the condition of elderly people in a home environment is indispensable if it is desired to lengthen the possibility of an aging population coping in its home environment. Safety bracelets are widely used. Their weakness is that the user must wear the bracelet continuously and must be able to press the alarm button in an emergency. Bracelets that check the state of health also exist, but one of their problems is false alarms.

Prior art has also sought solutions in which a film that is of piezoelectric material is installed on the floor, which film registers pressure changes caused by movement on the surface of the floor. Also known to be used are sensors to be installed on the floor, or under it, that detect the presence and movements of people without a change in pressure by means of capacitive sensors.

The possibility of using video cameras, movement detectors that are based e.g. on detecting infrared light, or e.g. ultrasound sensors for monitoring the condition and state of elderly people is also disclosed in prior art.

For example, specification WO2012164169 describes a method and system known in the art for tracking objects based on ultrasound technology.

A drawback with prior-art observation systems and monitoring systems is that they can interpret a person as having fallen in a situation in which the person has not really fallen. In such a case the system sends a false notification of a fall or a false fall alarm although there was no need for it in the situation in question. A false notification of a fall or a false fall alarm incurs costs because the recipient of the notification of a fall must ascertain whether the person has really fallen and whether he/she needs assistance.

### BRIEF DESCRIPTION OF THE INVENTION

The system according to the invention comprises at least one sensor for detecting the state and/or attitude of a person, said sensor being suited for measuring. In the solution according to the invention the sensors can be installed e.g. on a ceiling, floor or wall. The solution according to the invention can be used e.g. for monitoring the condition and state of elderly people e.g. in their own homes or in retirement homes.

By using the system according to claim 1 and the method according to claim 11, the problems of the state of the art can be eliminated and an arrangement can be implemented that corresponds to the requirements according to the needs of actual usage. The invention is characterized by what is disclosed in the claims below.

In the solution according to the invention a space is monitored with at least one sensor, which is adapted to measure in two measuring ranges that are at a different height, of which the first measuring range is an upper measuring range and the second measuring range is a lower measuring range. The system is adapted to interpret a person as having fallen if an object is not detected in the upper measuring range and an object is detected in the lower measuring range. The system is further adapted to send a notification of a fall if a person is interpreted as having fallen and the predetermined criteria attached to sending a notification are met. A notification of a fall can be sent e.g. to a central control room or to a corresponding body that supervises a certain area and/or people moving in it.

In one embodiment of the invention the system comprises at least two sensors and the system is adapted to send a notification of a fall if no sensor at all in the upper measuring range detects any objects at all.

In one embodiment of the invention the system is adapted to issue an alarm signal lasting a predetermined period of time in the area to be monitored before sending a notification of a fall. In the embodiment in question a notification of a fall is only sent if an object is not detected in the upper measuring range during the issuing of the alarm signal or within a certain time from when the alarm signal ceased to be issued.

One advantage, among others, in the system according to the invention compared to earlier systems is that the system functions reliably and does not issue false alarms or notifications associated with falling and, that being the case, also does not incur the unnecessary costs incurred by false notifications.

### BRIEF DESCRIPTION OF THE FIGURES

The invention is illustrated with the following drawings, of which

FIGS. 1A-C present a sensor according to an embodiment of the system according to the invention,

FIG. 2 presents the components of an embodiment of the system according to the invention in the area to be monitored,

FIG. 3 presents the operation of an embodiment of the system according to the invention.

### DETAILED DESCRIPTION OF THE INVENTION

In the solution of the invention, sensors to be installed e.g. on a wall or ceiling can be used, which sensors can detect the presence of an object by means of movement, heat or sound waves. The object can be e.g. an elderly person or some other person benefitting from supervision.

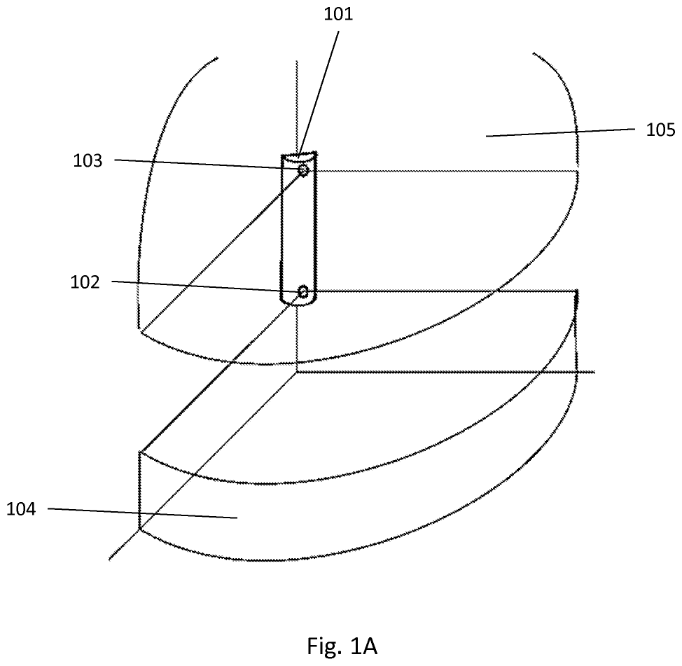

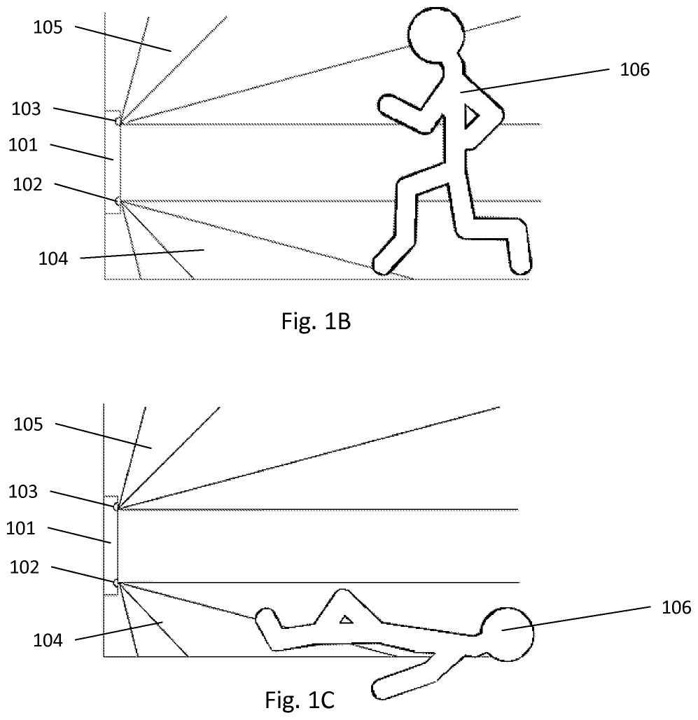

FIGS. 1A-C present a sensor according to an embodiment of the system according to the invention. The sensor 101 according to this embodiment is adapted to measure two sectors that are at different heights. The sensor 101 can be installed e.g., on a wall or in a corner of the area to be monitored, typically above the floor-level plane, e.g. at a height of approx. 40-50 cm from the floor. Corner installation suits the sensor well because its field of vision can be e.g. approx. 100 degrees on the horizontal plane. In one embodiment of the invention the sensor 101 has two motion detectors 102, 103, the field of vision of which is limited on the vertical plane in such a way that the measuring range 104 of the first detector 102 is limited to the bottom part of the area to be monitored and the measuring range 105 of the second detector 103 is limited to the top part of the area to be monitored. FIGS. 1B and 1C present as a cross-section the measuring ranges 104, 105 of the detectors 102, 103. In the solution of the invention it is good to arrange the measuring ranges of the detectors in such a way that the detector 103 monitoring the upper part of the area to be monitored detects a standing or upright moving person but not a person that is lying down or has fallen. In this way the system can distinguish an upright person from a person who has fallen e.g. in such a way that if an object 106 is detected with the upper detector, it is interpreted that the person is upright but if an object 106 is not detected with the upper detector and the object 106 is detected with the lower detector, it can be interpreted that the person has fallen. In one embodiment of the invention between the measuring ranges 104, 105 of the first detector 102 and the second detector 103 remains a vertical area, which does not belong to the measuring range of either detector.

The motion detectors 102, 103 of the sensor 101 can be e.g. passive infrared sensors (PIR), ultrasound sensors, microwave sensors or combination sensors, such as a combination of a passive infrared sensor and a microwave sensor or a combination of two passive infrared sensors. The detectors of the sensor 101 can also be implemented with other technologies, by means of which the sensor is adapted to measure the presence and/or movement of an object in two different measuring ranges 104, 105 in the height direction.

The system according to the invention further comprises measuring electronics that produces sensor observations by means of sensors, and a central unit, suited to processing sensor observations and comprising a processor and a memory, which central unit is e.g. a data processing device. The central unit of the system can manage one or more sensors or sensor groups, wherein one sensor group means e.g. the sensors in the same space, such as in the same room.

The processor, central unit and/or measuring electronics can be integrated into the sensors or they can be disposed separately or in separate units. In the embodiment described in FIG. 1 the program executed by the processor interprets the movements observed in the top and bottom parts of the area being monitored and gives an alarm if the alarm conditions defined for the program are fulfilled.

A sensor measuring two different height ranges can interpret the falling of an object e.g. according to the following conditions:
1. If movement is detected in the area to be monitored, go to item 2.
2. If movement is detected only in the bottom part of the area to be monitored, go to item 3.
3. Wait for a predetermined time, e.g. 30-180 seconds. If during this time movement is not detected in the top part of the area to be monitored, go to item 4. If movement is detected in the top part of the area to be monitored, go to item 1.
4. It is interpreted that a person has fallen, go to item 1.

The system is adapted to send a notification of a fall if a person is interpreted as having fallen and the predetermined criteria attached to sending a notification are met.

In the solution according to one embodiment of the invention after detecting a fall the system is adapted to issue an alarm signal lasting a certain predetermined period of time in the area to be monitored before sending a notification of a fall or a fall alarm. The alarm signal can be e.g. a sound signal and/or a light signal. The duration of the alarm signal can be e.g. 10 seconds. An alarm signal, e.g. a light and/or a sound, can be issued in pulses, e.g. at 1 s intervals, and can be stopped when movement is detected in the upper measuring range. The light can be e.g. green in color and/or the sound can be e.g. low, so that the person does not become anxious.

In one embodiment of the invention the system cancels the sending of a notification of a fall if the sensor that detected falling or another sensor in the upper measuring range detects an object during the issuing of an alarm signal. In one embodiment of the invention the system interrupts the issuing of an alarm signal if the sensor that detected falling or another sensor in the upper measuring range detects an object during the issuing of an alarm signal.

In these ways false notifications of a fall or false fall alarms are reduced in situations in which movement is not detected in the top part of the area to be monitored but movement is detected in the bottom part. In all cases the person has not actually fallen in such a situation but instead can be sitting in a chair or on a bed and waving his/her legs, in which case the upper body does not move but the legs do not move.

By means of an alarm signal a person in the area to be monitored will know that he/she must move or otherwise the system will send a notification of a fall or a fall alarm. The light and/or sound functioning as an alarm signal catches the person's attention and can easily e.g. get the person's head to turn. In such a case detectable movement occurs in the upper measuring range and the sending of a notification of a fall or of a fall alarm can be cancelled.

In one embodiment of the invention only some of the sensors of the area to be monitored have the functionality enabling the issuing of an alarm signal as described above. For example, the sensors in only some rooms, such as in the living room, can be provided with this functionality and the sensors in other rooms send a notification of a fall onwards immediately after detecting a falling event. In one embodiment of the invention only some of the sensors in one space, such as in a room, comprise the functionality enabling the issuing of an alarm signal as described above.

The system according to the invention can also combine the information of a number of sensors and deduce by means of the information of a number of sensors e.g. the movement and attitude of an object and e.g. the need for sending a fall alarm. In one embodiment of the invention the system examines the information measured by a number of sensors, e.g. by all the sensors in the area to be monitored, and a notification of a fall is only sent if no sensor at all in the upper measuring range detects any objects at all. In such a case movement detectable by some sensor in the upper measuring range can be movement caused by the actual object interpreted as having fallen or movement caused by some other person in the space. If the movement detectable by some sensor in the upper measuring range is movement caused by some other person, that person can assist the fallen person and the sending of a fall alarm is unnecessary. If the movement detected by a sensor in the upper measuring range is caused by the actual object interpreted as having fallen, the person has not actually fallen but instead he/she can be e.g. in a shadow zone of some sensor in the upper measuring range.

In the system there can also be a control center and the predetermined information concerning the presence, location, movement and/or attitude of the object can be sent to the control center. The alarm terms used by the system can be changed, e.g. on the basis of presence information received from an RFID reader. An alarm can be given e.g. to an external alarm system or wirelessly to a central server of the system, from which server the alarm is directed onwards.

The system can also have a memory means, in which the system is adapted to record a measurement signal, or information derived from it, for observing the chronological dependency of the area to be monitored and the behavior of objects. By means of this the system can give an alarm e.g. if a person being monitored has not got out of bed or visited the kitchen at a certain time, or if the person has gone to the toilet too often. The memory means also enables learning of a more common daily rhythm and the detection of aberrations occurring in it.

An area to be monitored with sensors can be the whole area or only a part of some area. The area to be monitored can be composed e.g. of one or more rooms and certain parts of the area, e.g. fixed installations such as cupboards, can be left outside the area to be monitored.

In some applications it is advantageous to first perform a charting of the unchanged area, i.e. to chart the measuring information of the sensors when mainly unmoving and unchanging objects and structures are in place. This type of situation is e.g. in a residential apartment when the furniture is in position but there are no people, pets or robots in the apartment. This charted information can be recorded in the system, e.g. in a memory that is located in the central unit or in a memory means that is in connection via a data network, which memory means can be e.g. in a control center or service center. For this purpose memory means must be comprised in the arrangement, which memory means can be in the central unit or connected to it via a data network.

According to one embodiment of the invention the system performs a charting of the unchanged area continuously or at defined intervals, in which case the system is able to detect e.g. changes in the area caused by new furniture or by changes in the location of furniture. In this way the system is able to adapt gradually to changes occurring in the area to be monitored.

By means of the sensors of the system the movements of an object can be checked. For the purposes of this function the central unit of the system comprises the necessary software and information about the characteristic properties of the signals being detected. Generally the central unit can deduce information from a signal received via a sensor, e.g. about the location, speed, movement direction, state or attitude of an object.

Generally, at least some of the sensors of the system are disposed in the proximity of those types of surfaces, or on the surfaces, such as e.g. floor surfaces, wall surfaces, door surfaces or ceiling surfaces of an apartment, of the area to be monitored to which, or into the proximity of which, the object has access.

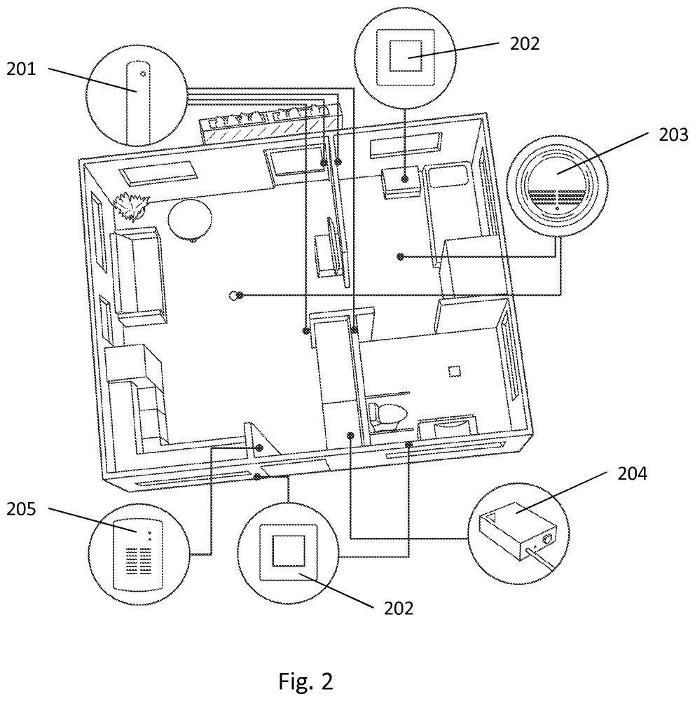

FIG. 2 presents the components of an embodiment of the system according to the invention in the area to be monitored. The sensor 201 or sensors to be used in the invention are disposed in connection with the area to be monitored in such a way that by means of the sensor 201 or sensors the area to be monitored can be monitored. A sensor can be e.g. a fall detector and it can be disposed in any apartment whatsoever. If sensors to be installed on top of a surface, e.g. a wall, floor or ceiling surface, are used they can be fastened to the surface e.g. with double-sided tape or with a sticker strip, in which case they can easily be removed. The sensors 201 can be connected wirelessly or by wireline to a gateway 204, which collects measured values obtained from the sensors 201 or status information formed by the sensors 201, e.g. about the objects detected, the state of health of the objects and/or the attitudes of the objects. The gateway 204 sends the information onwards e.g. to a control center or to another body that supervises the area and/or the objects therein. The transfer of information between the system and some recipient can be performed e.g. using a phone connection, a wireline broadband connection or wireless connections. It is advantageous in the data transfer to take into account issues relating to data security and privacy, which many official regulations also address.

In one embodiment of the invention the sensor 201 or sensors comprise their own central unit and the central unit of a sensor is in connection with the gateway 204. In a second embodiment of the invention the central units of the sensor 201 or sensors are integrated into a gateway 204.

It is possible that some of the functions of the central unit or of the gateway 204 are performed elsewhere via a data network connection, e.g. in a central control room or service center.

According to one embodiment of the invention, an alarm signal given by the system and lasting a predetermined period of time in the area to be monitored and that can be given before the sending of a notification of a fall, can be given via a light unit and/or a sound unit of the system. The light unit and/or sound units can be in each different part, e.g. room, of the premises. This functionality can also be integrated into the sensors, e.g. into all the sensors or only some of the sensors.

The system according to the invention can also comprise a call pushbutton 202, after the pressing of which the system can form a connection e.g. to nursing personnel, security personnel or it can perform various alarm procedures. The call pushbutton can be wireless and it can be adapted to function without batteries.

The notification procedures and alarm procedures according to the system of the invention can include e.g. the starting of alarm indication signaling (buzzer, light, siren, alarm clock), making contact with an alarm center or service center, a care provider or a relative. In some cases, an alarm can also be given directly to the person being monitored or to the user, e.g. by means of speech synthesis or a speech recording. For performing these tasks the arrangement can comprise means needed for processing time data, such as e.g. a clock circuit.

The system according to the invention can also comprise fire detectors 203, which can be in connection with another system via a wireline or wireless connection. If the fire detectors 203 warn of a fire, alarm procedures can be performed, e.g. by sending an alarm message to a control center or to the rescue authorities.

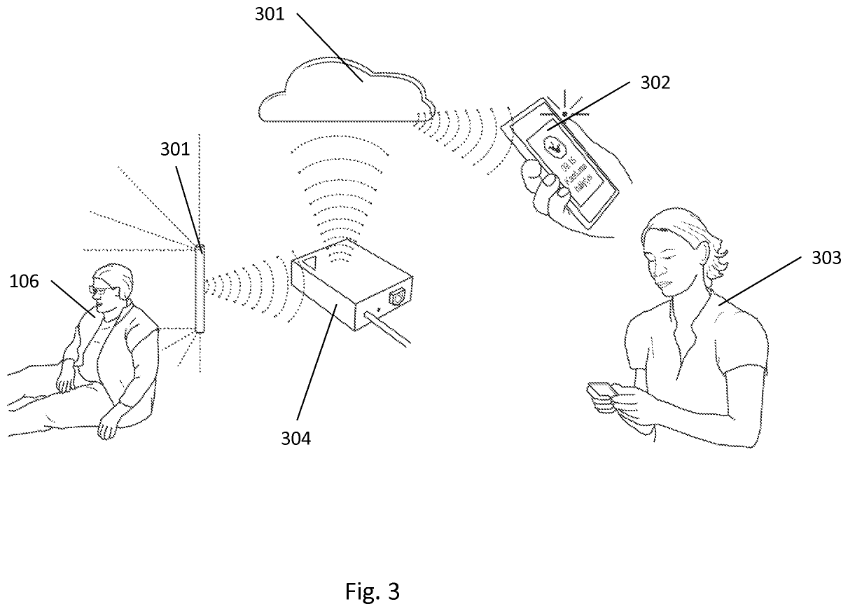

FIG. 3 presents the operation of an embodiment of the system according to the invention, in which the state of health or attitude of a person 106 in the area to be monitored is monitored. When the sensors 201 of the system detect that an object 106 in the area to be monitored has fallen, the system checks whether the predetermined criteria attached to sending a notification of a fall are met.

In one embodiment of the invention the system issues an alarm signal lasting a predetermined period of time in the area to be monitored before sending a notification of a fall. If the sensor that detected falling or another sensor in the upper measuring range still does not detect movement during the issuing of an alarm signal or after issuing it, the system sends a notification of a fall and/or a fall alarm via the system gateway 304 onwards and at the same time the system can perform predetermined fall alarm procedures or notification procedures.

In one embodiment of the invention the system examines the information measured by a number of sensors, e.g. by all the sensors in the area to be monitored, and a notification of a fall is only sent if no sensor at all in the upper measuring range detects any objects at all.

In one embodiment of the invention the system examines the information measured by a number of sensors, e.g. by all the sensors in the area to be monitored, and an alarm signal lasting a predetermined period of time is only issued if no sensor at all in the upper measuring range detects any objects at all. If still no sensor in the upper measuring range detects movement during the issuing of an alarm signal or after issuing it, the system sends a notification of a fall and/or a fall alarm via the system gateway 304 onwards and at the same time the system can perform predetermined fall alarm procedures or notification procedures.

In one embodiment of the invention the system issues an alarm signal lasting a predetermined period of time in the area to be monitored before sending a notification of a fall. If a certain sensor detecting falling in the upper measuring range still does not detect movement during the issuing of an alarm signal or after issuing it, the system examines the information measured by a number of sensors, e.g. by all the sensors in the area to be monitored. In such a case a fall alarm or a notification of a fall is sent if no sensor at all in the upper measuring range detects movement.

In the situation in the embodiment presented in FIG. 3, in which the predetermined criteria attached to sending a notification of a fall are met, the sensor 201 sends information about the falling of an object, e.g. a fall alarm, to the gateway 304 of the system and the gateway 304 sends the information and/or an alarm onwards to the server 301 e.g. via an Internet connection or via some other connection. From the server 301 the information and/or alarm is sent to a body monitoring the health of the person, e.g. as a message to a phone 302, as an alarm and/or e.g. to a nurse 303, to relatives or to an emergency center. In this way e.g. information about the falling of the person reaches the necessary people or organizations and the person who fell receives help as quickly as possible. In one embodiment of the invention the system can send information directly from the gateway 304 to a body monitoring the health of the person.

It is obvious to the person skilled in the art that the different embodiments of the invention are not limited solely to the examples described above, and that they may therefore be varied within the scope of the claims presented below. The characteristic features possibly presented in the description in conjunction with other characteristic features can if necessary be used separately to each other.

1. A system for observing the presence, location, movement and/or attitude of one or more objects to be monitored in an area to be monitored, the system comprising at least one sensor fitted into some part of the area to be monitored,
wherein the at least one sensor is a sensor detecting movement and/or presence, the sensor being adapted to measure in two measuring ranges that are at a different height, of which the first measuring range is an upper measuring range and the second measuring range is a lower measuring range,
wherein the system is adapted to interpret a person as having fallen if an object is not detected in the upper measuring range and an object is detected in the lower measuring range, and
wherein the system is further adapted to send a notification of a fall if a person is interpreted as having fallen and the predetermined criteria attached to sending a notification of a fall are met.

2. The system according to claim 1, wherein the system comprises at least two sensors, and the system is adapted to send a notification of a fall if no sensor at all in the upper measuring range detects any objects at all.

3. The system according to claim 1, wherein the system is adapted to issue an alarm signal lasting a predetermined period of time in the area to be monitored after detecting a fall,
and is further adapted to send a notification of a fall if an object is not detected in the upper measuring range during the issuing of an alarm signal or within a certain time from when the alarm signal ceased to be issued.

4. The system according to claim 3, wherein the alarm signal is a noise signal and/or a light signal.

5. The system according to claim 3, wherein the system is adapted to cancel the sending of a notification of a fall if an object is detected in the upper measuring range during the issuing of an alarm signal.

6. The system according to claim 3, wherein the system is adapted to interrupt the issuing of an alarm signal if an object is detected in the upper measuring range during the issuing of the alarm signal.

7. The system according to claim 1, wherein a fall alarm is the sending of an alarm or of a message to the body monitoring the health of the object.

8. The system according to claim 1, wherein the measuring ranges of the at least one sensor essentially covers the area to be monitored.

9. The system according to claim 1, wherein the system is adapted to send information derived from the object onwards using a wireline or wireless telecommunications connection.

10. The system according to claim 1, wherein the system is adapted to interpret a person as having fallen if an object is not detected in the upper measuring range during a certain period of time and an object is detected in the lower measuring range.

11. A method for observing the presence, location, movement and/or attitude of one or more objects to be monitored in an area to be monitored with a system that comprises at least one sensor fitted into some part of the area to be monitored,
wherein the at least one sensor is a sensor detecting movement and/or presence, the sensor measuring in two measuring ranges that are at a different height, of which the first measuring range is an upper measuring range and the second measuring range is a lower measuring range, and
in which method:
a person is interpreted as having fallen if an object is not detected in the upper measuring range and an object is detected in the lower measuring range, and
wherein the system sends a notification of a fall if a person is interpreted as having fallen and the predetermined criteria attached to sending a notification of a fall are met.

12. The method according to claim 11, wherein the system comprises at least two sensors, and in which method a notification of a fall is sent if no sensor at all in the upper measuring range detects any objects at all.

13. The method according to claim 11, wherein an alarm signal lasting a predetermined period of time is given in the area to be monitored after detecting a fall, and the system sends a notification of a fall if an object is not detected in the upper measuring range during the issuing of an alarm signal or within a certain time from when the alarm signal ceased to be issued.

14. The method according to claim 13, wherein the alarm signal is a noise signal and/or a light signal.

15. The method according to claim 13, wherein the sending of a notification of a fall is cancelled if an object is detected in the upper measuring range during the issuing of an alarm signal.

16. The method according to claim 13, wherein the issuing of an alarm signal is interrupted if an object is detected in the upper measuring range during the issuing of the alarm signal.

17. The method according to claim 11, wherein a fall alarm the sending of an alarm or of a message to the body monitoring the health of the object.

18. The method according to claim 11, wherein the measuring ranges of the at least one sensors essentially cover the area to be monitored.

19. The method according to claim 11, wherein information derived from the object is sent onwards using a wireline or wireless telecommunications connection.

20. The method according to claim 11, wherein a person is interpreted as having fallen if an object is not detected in the upper measuring range during a certain period of time and an object is detected in the lower measuring range.
